(19) United States
(12) Patent Application Publication
(10) Pub. No.: US 2017/0320231 A1
(43) Pub. Date: Nov. 9, 2017

(54) PALLET MACHINE WITH IMPROVED NAILING SYSTEM

(71) Applicant: Jonathon E. Gudim, Coon Rapids, MN (US)

(72) Inventor: Jonathon E. Gudim, Coon Rapids, MN (US)

(21) Appl. No.: 15/330,135

(22) Filed: Aug. 13, 2016

Related U.S. Application Data
(60) Provisional application No. 62/391,547, filed on May 3, 2016.

(51) Int. Cl. B27M 3/00; B23P 19/04; B23P 19/00

(52) U.S. Cl. CPC B27M 3/0073; B23P 19/004; B23P 19/04

(57) ABSTRACT

A pallet machine (10) includes improved fastening systems (30, 106) for nailing the boards (16, 18) to the stringers (14). Each fastening system (30, 106) includes a vibratory nail bowl (38), a movable nail holder (40) and transfer block (42), and nailing assemblies (58). The transfer block (42) includes a pick plate (45) movable between blocking and feeding positions so that nails can be simultaneously fed to the nailing assemblies (58). The nailing assemblies (58) include recessed mounts (68, 70) and bearings (74) for better load transfer and distribution from recoil during high cyclical operation.

### TECHNICAL FIELD

The present invention relates generally to automated machine tools, and more particularly to a new and improved pallet assembly machine.

### BACKGROUND OF THE INVENTION

Pallets are used extensively to facilitate movement of all manner of goods and products in commerce. Such pallets are usually made of wood, and are produced in many sizes and configurations depending upon the goods or products to be shipped. They generally consist of transverse boards fastened to opposite edges of longitudinal stringers. Although pallets are not of complicated construction, they are carefully designed and engineered to provide the required foundational support for the loads being carried. It is thus important that they be properly assembled to achieve the desired structural integrity.

In the past, pallets were constructed primarily by hand with powered nail guns. This technique was labor intensive, time consuming and inefficient, and production was limited.

More recently, machines have been available for automating pallet construction. Such machines are available from various sources, including Viking Engineering & Development of Fridley, Minn., the assignee hereof.

While automated pallet machines are much more efficient in producing pallets in greater volume, they have not been without their drawbacks. Inertial factors become more significant at high production rates. It thus becomes more difficult to maintain proper alignment and relative location of the components, which in turn can affect quality, structural integrity and durability of the pallets.

In addition to the challenges of maintaining proper alignment and relative location of the pallet components, it is also important that the boards be fastened to the stringers in an accurate and repeatable manner, which in turn becomes more difficult at high production rates. Such pallet machines typically incorporate multiple fastening systems and nailing stations. Each fastening system includes multiple nail gun assemblies and associated nail delivery assemblies, which are actuated both simultaneously and cyclically to fasten the boards to the stringers. Rapid, accurate delivery of the nails to the nail gun assemblies is critical. The repeated cyclical loads by the nail gun assemblies cause cumulative wear and misalignment adversely affecting accuracy during fastening of the boards to the stringers, which in turn can also affect structural integrity and durability of the pallets.

A need has thus arisen for a pallet machine with new and improved fastening systems having more secure mounting for the nail guns and more accurate nail feed in order to achieve higher production rates.

### SUMMARY OF THE INVENTION

The present invention comprises an improved pallet making machine which overcomes the foregoing and other difficulties associated with the prior art. In accordance with the invention, the pallet machine herein incorporates unique fastening systems with improved nail delivery and nail gun assemblies adapted to provide more secure mounting and more accurate nail feed during high production rates while maintaining repeatability, quality and structural integrity of the pallets.

### BRIEF DESCRIPTION OF DRAWING

A better understanding of the invention can be had by reference to the following Detailed Description in conjunction with the accompanying Drawing, wherein:

FIG. 1 is a perspective view of the improved pallet machine in accordance with the present invention;

FIG. 2 is a top plan thereof;

FIG. 3 is a side elevational view thereof;

FIG. 4 is a right elevational end view thereof;

FIG. 5 is a diagram illustrating the pallet assembly sequence;

FIG. 6 is a cross-sectional view taken along lines 6-6 of FIG. 3 in the direction of the arrows;

FIG. 7 is a partial perspective view of the first nailing station taken along line 7-7 of FIG. 2 in the direction of the arrows;

FIG. 8 is a partial cutaway view of the nail delivery assembly;

FIG. 9 is a detail view of the nail picker in the nail feed assembly;

FIG. 10 is a partial, top perspective view of the lower end of the nail feed assembly;

FIG. 11 is an enlarged cross-sectional of the lower end of the nail feed assembly;

FIG. 12 is a side view of the flipper;

FIG. 13 is cross-sectional view of the nail gun assembly taken along line 13-13 of FIG. 4 in the direction of the arrows;

FIG. 14 is cross-sectional view of the nail gun assembly taken along lines 13-13 of FIG. 4 in the direction of the arrows; and

FIG. 15 is partial perspective view taken along line 15-15 of FIG. 6 in the direction of the arrows,

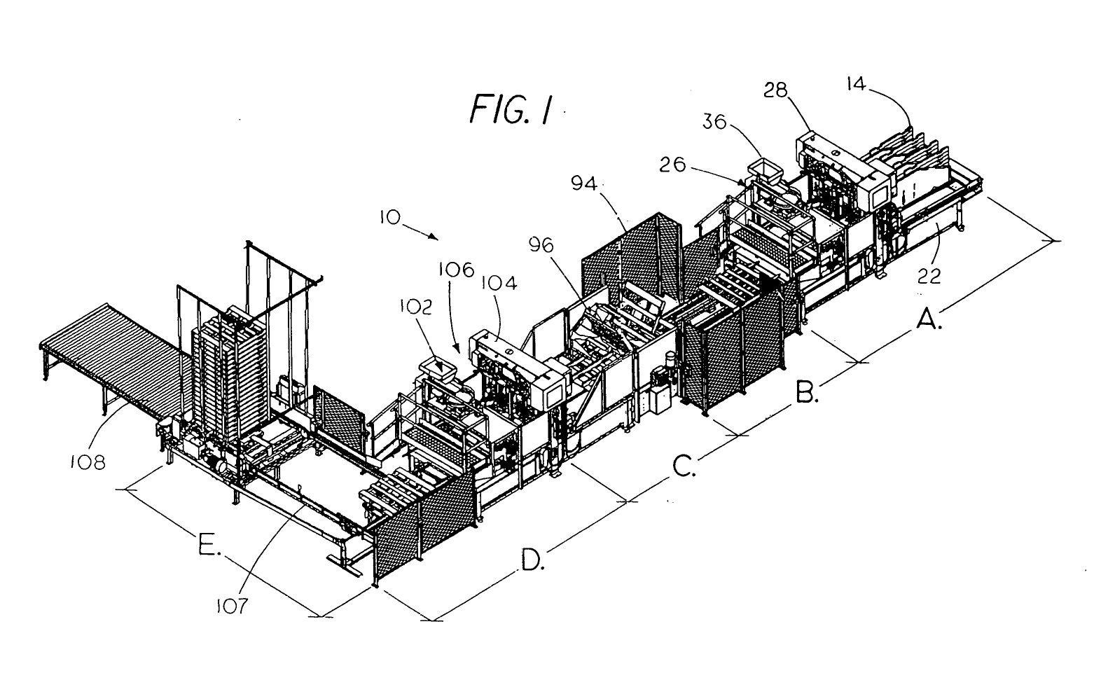

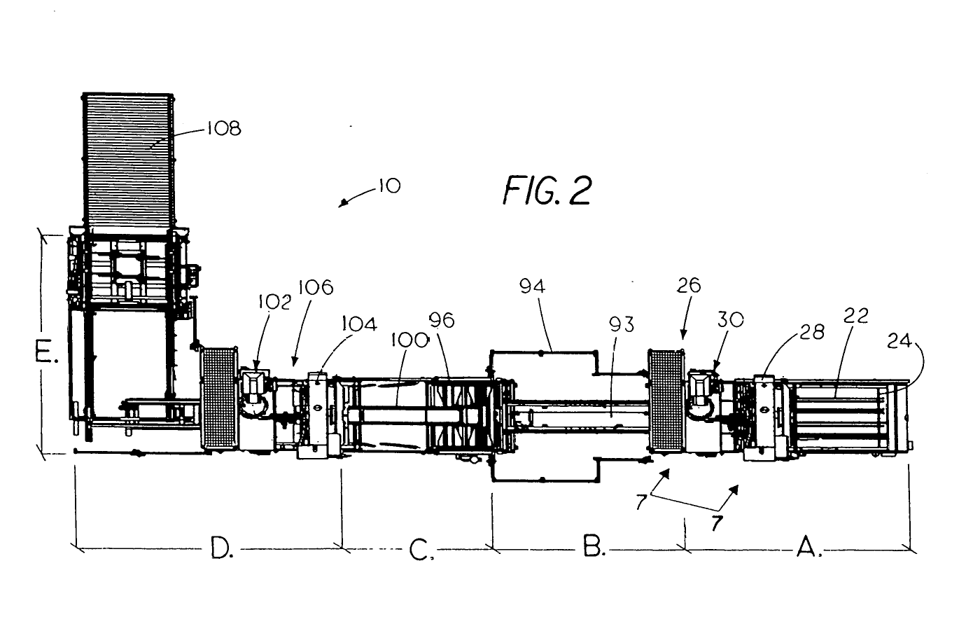

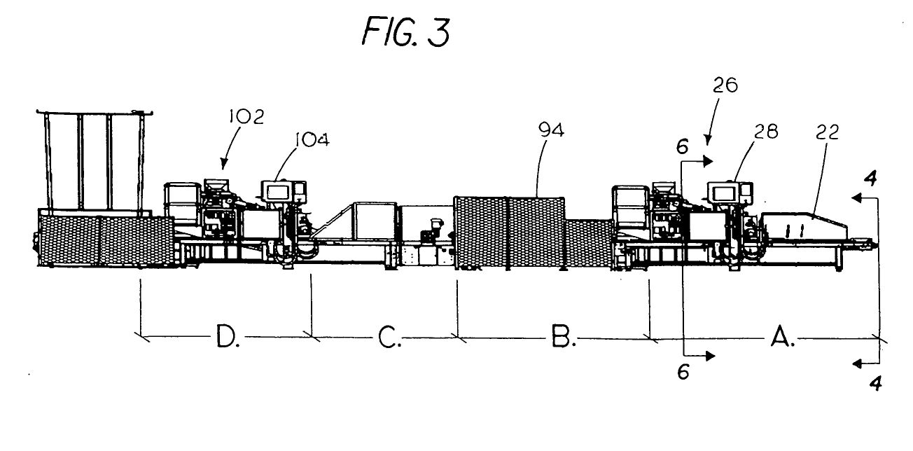

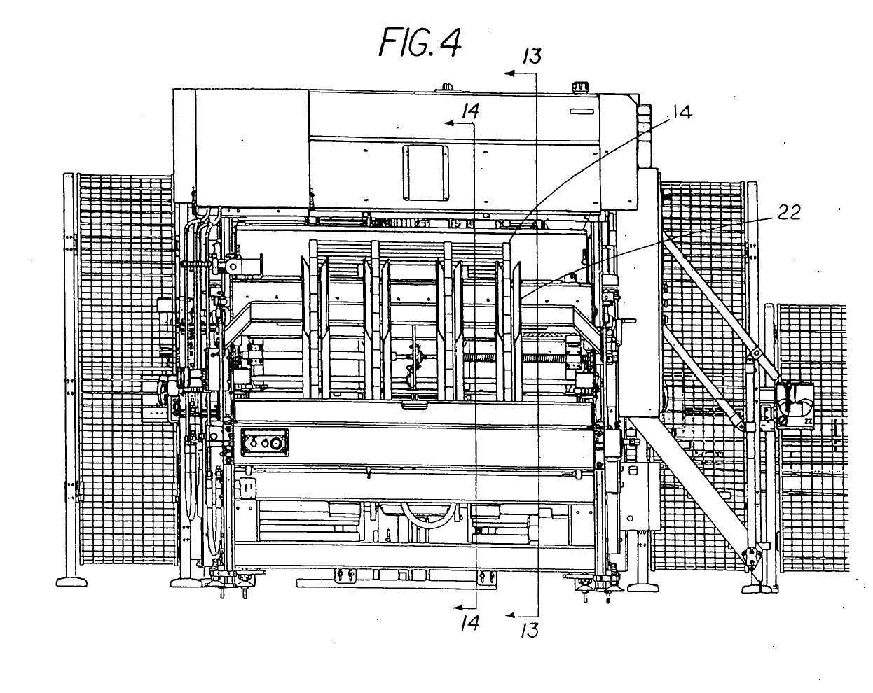

### DETAILED DESCRIPTION

Referring now to the Drawing, wherein like reference numerals designate like or corresponding elements throughout the views, there is shown the improved pallet assembly machine 10 of the invention. As will be explained more fully hereinafter, the pallet machine 10 allows for better nail feed and mounting of the nail guns in the fastening systems at the nailing stations so as to achieve high production rates while maintaining repeatability, quality and structural integrity of the pallets.

The pallet 12 consists of longitudinal stringers 14 and boards 16 and 18 fastened to the bottom and top edges, respectively, of the stringers. The stringers 14 usually include notches 20 in their lower edges for receiving the arms of a forklift (not shown) for lifting the pallet 12.

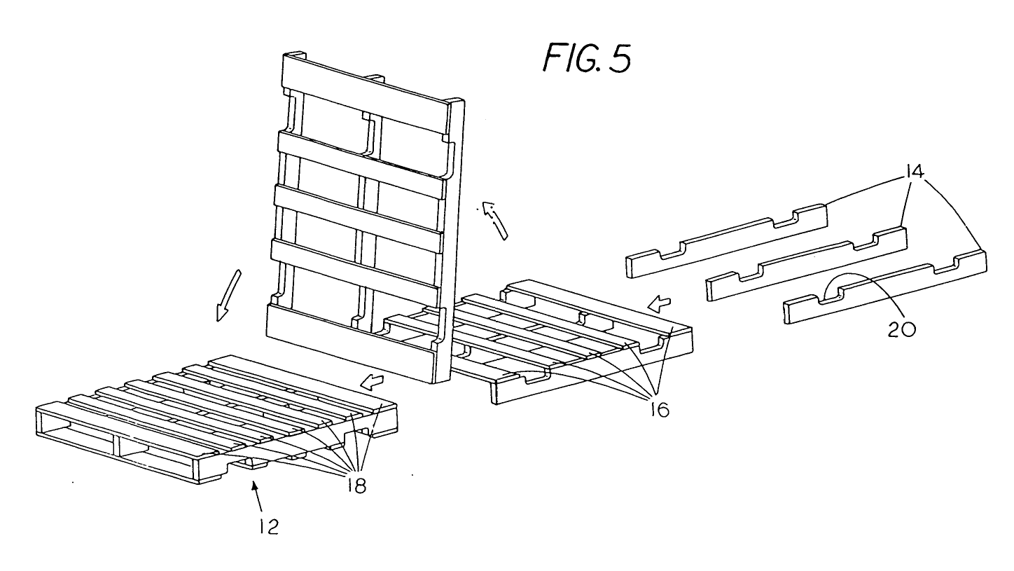

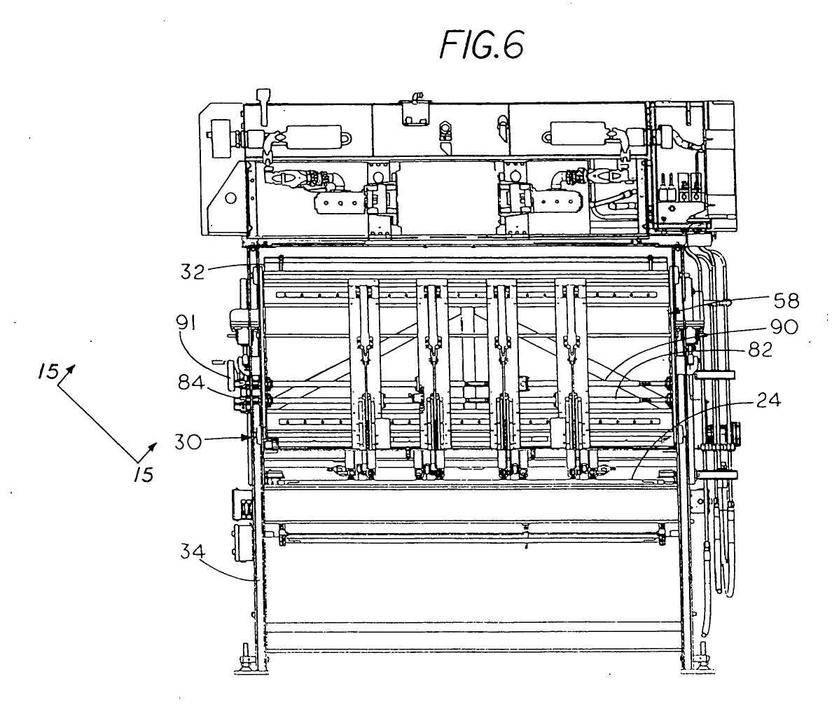

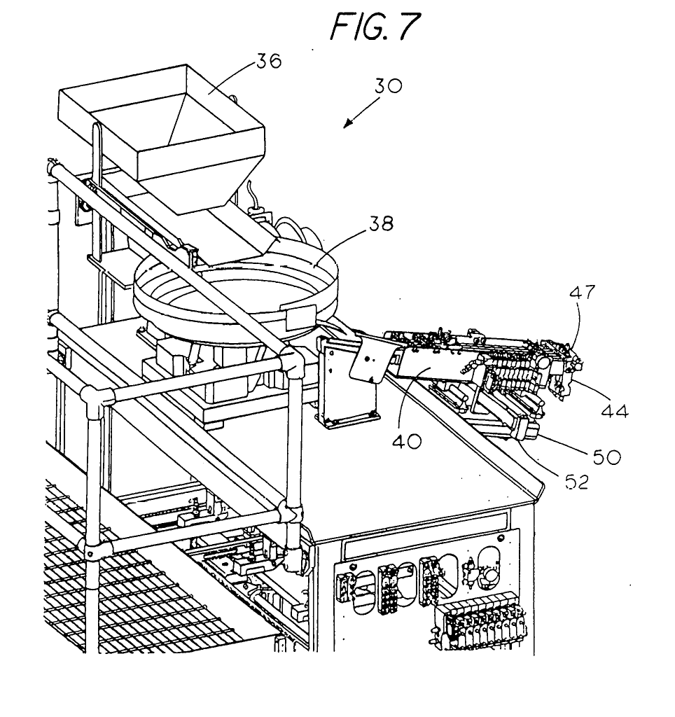

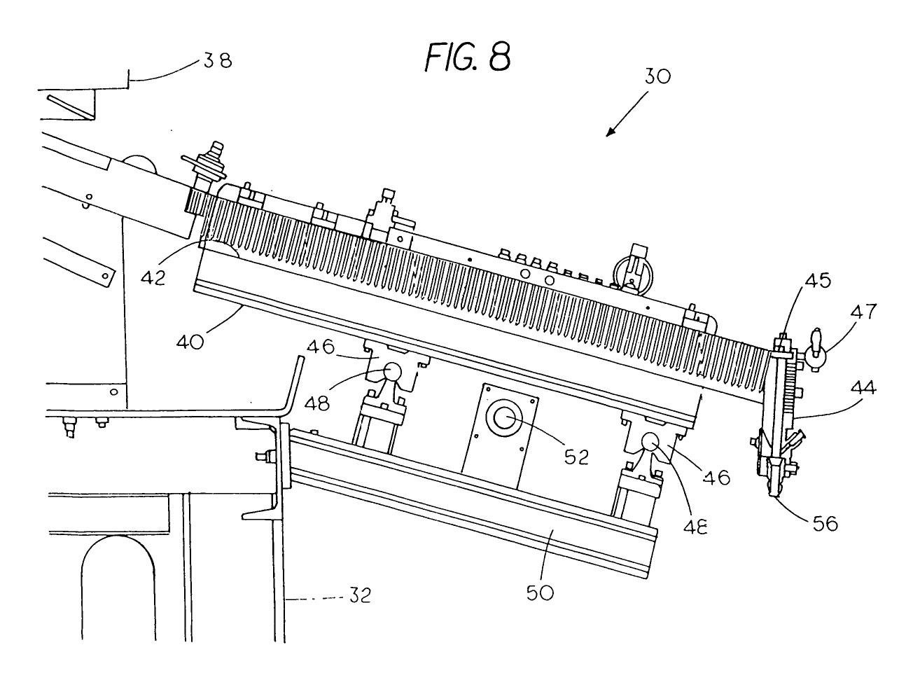

The pallet machine 10 includes a first section A wherein the stringers 14 are loaded into hoppers 22 upside down with the notched edges of the stringers facing upward, and then advanced onward for fastening of bottom boards 16 to the stringers. As shown, machine 10 is adapted to manufacture pallets 12 having four stringers 14, although the pallet shown in FIG. 5 includes only three stringers, for purposes of illustration. The stringers 14 are then advanced or indexed on a flight conveyor 24 into a first nailing station 26, which includes a hopper 28 loaded with bottom boards 16. The boards 16 are positioned across the stringers 14 and then nailed in place by fastening assembly 30. The conveyor 24 may be constructed like that shown in U.S. Pat. Nos. 4,782,989, 5,312,022 and 5,379,513, the entire disclosures of which are incorporated herein by reference.

The fastening system 30 includes nail delivery components mounted on a subframe 32 that is itself mounted on the main frame 34 of machine 10. Subframe 32 and mainframe 34 are preferably formed from sections of steel tubing arranged and welded together into a rigid structure.

Fastening system 30 includes a hopper 36, into which loose nails are manually loaded from above, and a vibratory bowl 38 for receiving the loose nails from the hopper and then advancing them onward, in line, with their sharp or pointed ends first, toward the outlet of the bowl. The vibratory bowl 38 can be constructed similarly to that shown in U.S. Pat. No. 5,715,985, the entire disclosure of which is incorporated herein by reference.

In the preferred embodiment of the invention, the fastening system 30 includes a single hopper 36 and associated vibratory nail bowl 38, instead of multiple hoppers and nail bowls. This arrangement avoids the higher cost and maintenance typical of the prior art, contributing to better operation and production.

The nails from bowl 38 are received by a nail holder 40 which includes four vertical grooves or tracks 42 for arranging the nails into columns. As shown, the top surface of nail holder is flat and angled downwardly, with the upper end of the holder located so as to receive nails from the outlet of bowl 38. Each groove or track 42 is wider than the shanks of the nails, but narrower than the diameters of their heads so that the nails will hang downward and then slide along forming columns in the holder 40, for receipt by a transfer block 44 mounted on the lower end of the nail holder.

The nail holder 40 is mounted for side to side or transverse movement on linear bearings 46 supported on linear shafts 48 secured to an arm 50, which is attached to the subframe 32. Movement of holder 40 is controlled by a linear actuator 52 across the nail outlet of bowl 38 in order to keep the grooves or tracks 42 of holder 40 full of nails.

The nails in tracks 42 of holder 40 are individually fed to corresponding vertical bores 41 within the transfer block 44 mounted at the lower end of the nail holder. A movable pick plate 45 with a slotted edge leading to a row of holes therein is provided. The pick plate 45 is mounted on top of transfer block 44 for side-to-side or tranverse movement between feed and blocking positions relative to the tracks 42 at the adjacent lower end of nail holder 40. In the blocking position, nails in the tracks 42 of holder 40 are stopped by plate 45 from advancing. In the feed position, the first nails in the tracks 42 of holder 40 are advanced through the slots in the edge of plate 45 and into the holes in plate 45, which are larger in diameter than the head of the nails. The holes in pick plate 45 are thereby adapted for selective alignment with the bores 41 in the transfer block 44.

Transfer block 44 also has corresponding pneumatic inlets 54 and outlets 56 on the upper and lower sides, respectively. The inlets 54 are connected to tubes 55 leading to a source of air pressure. The outlets 56 are connected to tubes 57 for sending the nails onward to the nailing assemblies 58.

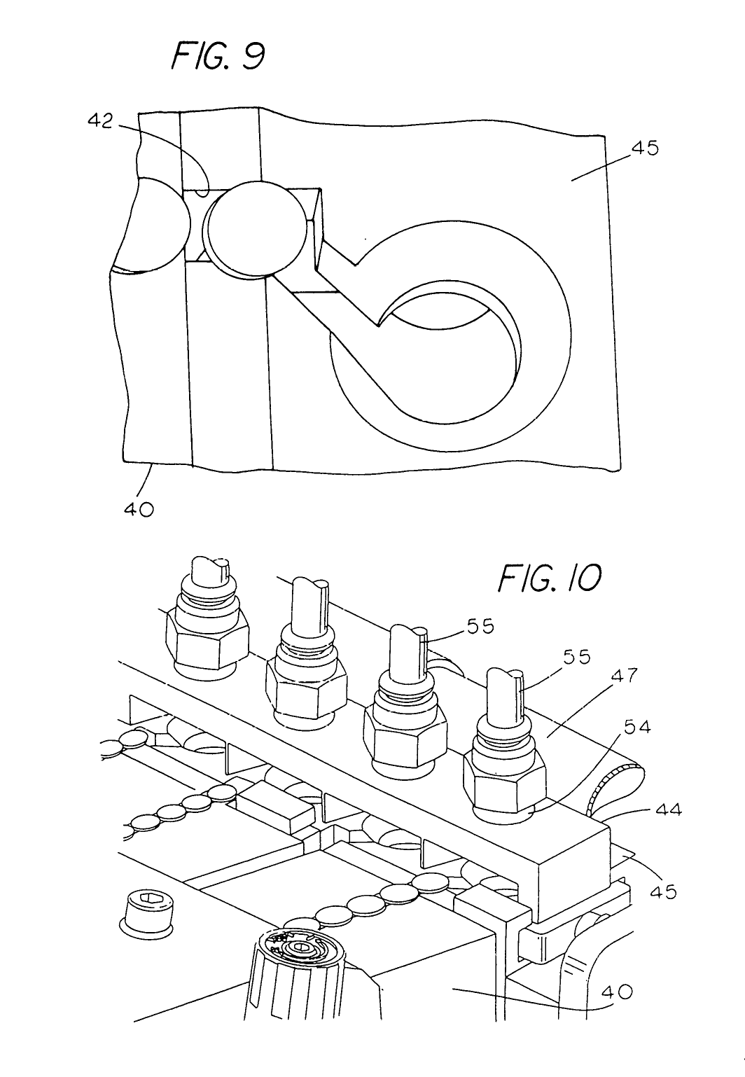

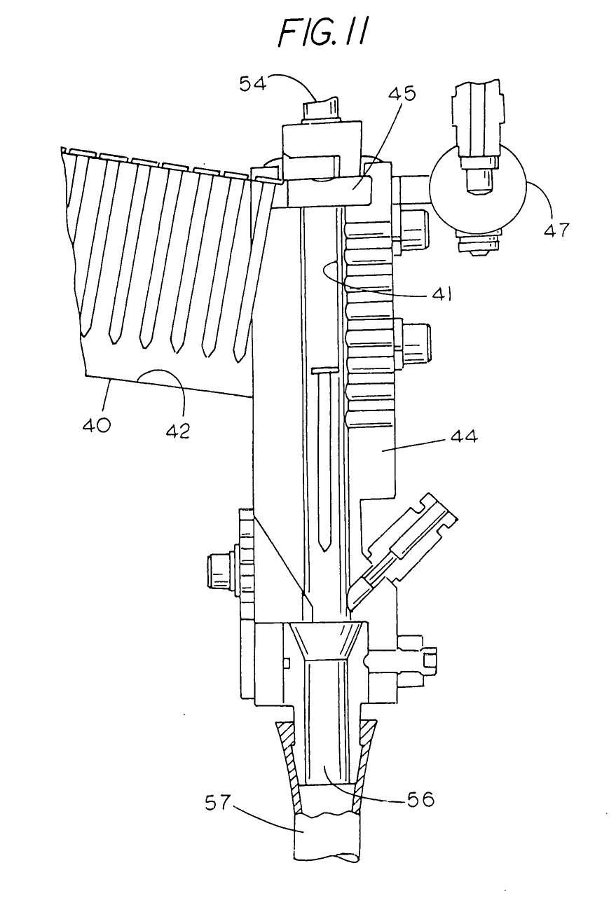

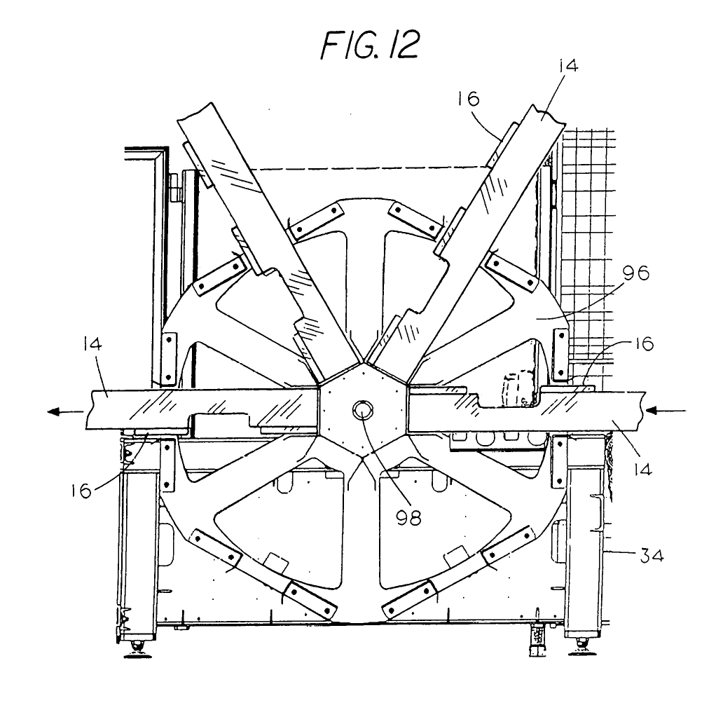

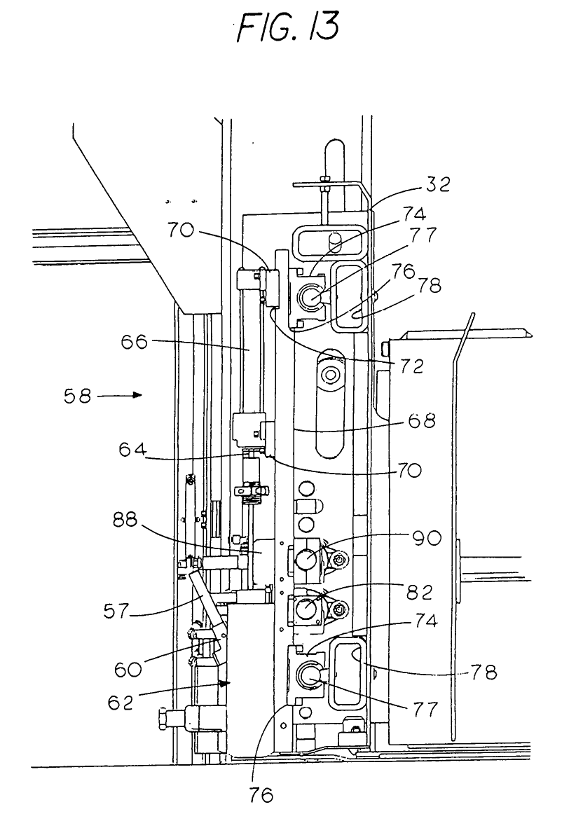

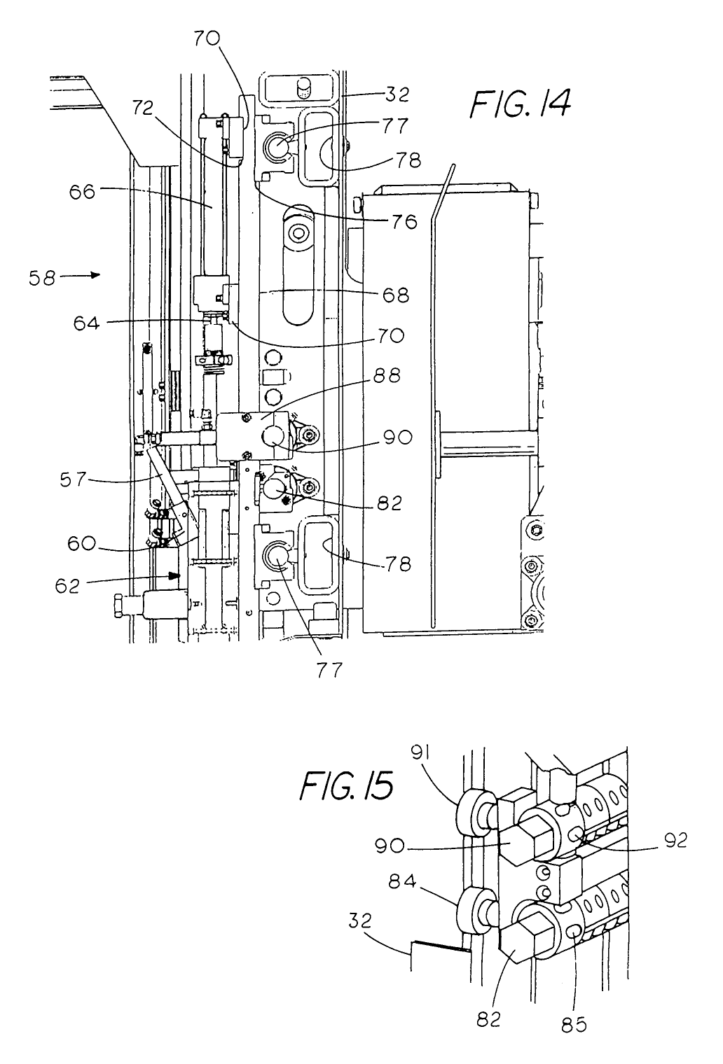

FIG. 9 shows the pick plate 45 of the transfer block 44 in a position blocking transfer of nails from the tracks 42 of nail holder 40 to the vertical bores 41 of the transfer block 44. Positioning of pick plate 45 is controlled by pneumatic cylinder 47.

It will thus be understood that the fastening system 30 includes a single hopper 36 and associated vibratory nail bowl 38, together with a nail holder 40 that is selectively movable across its outlet so as to keep the tracks 42 full of nails, for more rapid nail delivery. The pick plate 45 on the transfer block 44 is movable across the lower end of the holder 40 so that individual nails then can be fed simultaneously into the bores 41 of the transfer block and then on to the nailing assemblies 58. Multiple nails are thus transferred from the holder 40 for simultaneous, individual feeding onward to the nailing assemblies 58. This unique arrangement comprises a significant feature of the present invention.

The outlets 56 of the nail transfer block 44 are thus connected in fluid communication by tubes 57 with the feed inlets 60 of the nail chucks 62 in order to load the nails for driving through boards 16 and into stringers 14. Each nail chuck 62 includes a vertical bore receiving a drive pin 64 driven by a hydraulic cylinder 66.

The nail chuck 62 and associated drive pin 64 and cylinder 66 are secured to a mounting plate 68, which itself is supported for side to side or transverse movement on the subframe 32. In particular, each cylinder 66 is secured to two feet or pads 70, the uppermost one of which is snugly seated in direct contact within a recess 72 machined into the face or front side of the plate 68 in order to provide for better load transfer and distribution from recoil of the nail chuck 62 during operation.

If desired, the lower pad 70 could also be snugly seated in direct contact within a similar recess machined into the face of plate 68.

Linear bearings 74 are seated in recesses 76 machined into the other or back side of the mounting plate 68, which bearings in turn are carried on transverse shafts 77 so that lateral positioning of the nailing assemblies 58 can be adjusted according to the type of pallets 12 being assembled. The linear shafts 77 are supported on transverse arms 78 secured to the subframe 32. As shown, two bearings 74 and associated shafts 77 and support arms 78 are provided in the preferred embodiment.

It will be understood that this particular mounting and securing of such components in recesses on the plate 68 provides important advantages. The recoil loads from simultaneous, cyclical actuation of the nailing assemblies 58 is better absorbed and distributed into the subframe 32 and main frame 34 by this unique arrangement. This comprises a significant feature of the present invention.

The nailing assemblies 58 are mounted for tranverse or lateral adjustment, depending upon the type of pallet 12 to be made. Positioning of the nailing assemblies 58 can be adjusted with threaded shafts like that shown in U.S. Pat. No. 5,312,022. In particular, threaded nuts 80 are secured to the mounting plates 68 of the outer nailing assemblies 58. The nuts 80 are carried on a threaded shaft 82, the ends of which are threaded in opposite directions. The shaft 82 is journaled for rotation on uprights secured to the subframe 32. The end of shaft 82 is hexagonal with wrench flats, as best seen in FIG. 9. When shaft is turned or cranked, the outer nailing assemblies 58 thus move inwardly towards each other or outwardly away from each other, simultaneously, for proper positioning over the outer stringers 14. After the outer nailing assemblies 58 have been selectively positioned, shaft 82 is locked with a spring pin 84 on the subframe 32 and associated holes 85 circumferentially spaced on the shaft.

Location of the inner nailing assemblies 58 is adjusted by means of nuts 86 and 88 and a separate threaded shaft 90, whose end is similarly hexagonal with wrench flats. A similar locking pin 91 and associated holes 92 are provided for securing shaft 90 so that the inner nailing assemblies 58 are in the desired positions over the inner stringer 14. Nut 88 is a pneumatically controlled, for selective releasable engagement with the shaft 90, depending upon the number of stringers 14 of the pallets 12 to be made. Nut 88 is normally disengaged if the pallets 12 to be made have three stringers 14, but can be selectively engaged for proper positioning if there are four stringers.

After the stringers 14 and first board 16 have been properly positioned in the first nailing station 26, the fastening system 30 is actuated. Cylinder 47 is actuated to move pick plate 45 to the feed position, taking nails from the nail holder 40 and loading the into the bore 41 transfer block 44. The inlets 54 of transfer block 44 receive high pressure pulses of air through tubes 55 to send the nails therein out of the outlets 56 and through tubes 57 to load the nail chucks 62. The cylinders 66 are then actuated, pins 66 drive the nails downward simultaneously to fasten a board 16 to the stringers 14, after which the nailing assemblies 58 reset as conveyor 24 advances in preparation for putting a second set of nails into the board, or fastening the next board positioned on the stringers 14. This cycle is repeated until all of the boards 16 have been nailed at least once to each of the stringers 14.

After the bottom boards 16 have been fastened to stringers 14, the semi-completed pallet 12 is advanced into section B for marking or labeling of the stringers as desired. Section B includes an intermediate conveyor 93 for advancing the semi-completed pallet 12 along the feed path to section C. An enclosure 94 is also provided on either side of conveyor 93 of section B.

After the semi-completed pallet 12 has been marked or labeled in section B of machine 10, it is then turned upright by turner or flipper 96 in section C so that the bottom boards 16 are down and the top edges of the stringers 14 are upright, as

FIG. 5 illustrates. Flipper 96 may be constructed like that shown in U.S. Pat. No. 4,782,989.

In the preferred embodiment, flipper 96 includes six radial compartments at equal sixty degree intervals, for better production. This arrangement allows for simultaneous receipt of one semi-completed pallet, discharge of another, and transit of two others, as the flipper 96 is indexed about its mounting shaft 98.

After the semi-completed pallet 12 has been flipped upright in section C, it is advanced into section D for fastening of the top boards 18. Section D includes a conveyor 100, a second nailing station 102, and a hopper 104 loaded with top boards 18. The boards 18 are positioned on the stringers 14 and nailed in place by a second fastening system 106, which is constructed similarly to fastening system 30, to complete assembly of pallet 12. The conveyor 100 may be constructed like that shown in U.S. Pat. Nos. 4,782,989, 5,312,022 and 5,379,513.

After assembly of pallet 12 has been completed in section D, it is then advanced on a right angle conveyor 107 to section E for stacking and removal. Section E may be constructed like that shown in U.S. Pat. No. 5,984,621, the entire disclosure of which is incorporated by reference herein. An optional roller conveyor 108 may be used to facilitate removal and distribution of the completed pallets 12.

From the foregoing, it will be appreciated that the present invention comprises an improved pallet machine having several advantages over the prior art. One significant advantage is that the nailing stations of the pallet machine herein incorporate unique fastening systems providing for fast, accurate, reliable and simultaneous feeding of nails from a single nail bowl. In addition to better nail feeding, more secure mounting of the nail gun assemblies is provided for better load distribution and transfer during repeated cycles. High production rates can be achieved while maintaining repeatability, quality and structural integrity of the pallets. Other advantages will be evident to those skilled in the art.

Although particular embodiments of the invention have been illustrated in the accompanying Drawing and described in the foregoing Detailed Description, it will be understood that the invention is not limited only to the embodiments disclosed, but is intended to embrace any equivalents, modifications and/or rearrangements of elements falling within the scope of the invention as defined by the following Claims.

What is claimed is:

1. Apparatus for manufacturing pallets, comprising:
means defining a predetermined feed path;
means for feeding a plurality of stringers in predetermined longitudinal orientation along said feed path;
means for feeding a plurality of first boards in predetermined transverse orientation onto the stringers on said feed path;
first means for fastening said first boards to said stringers, said fastening means including a single vibratory nail bowl and a plurality of nail guns mounted in transverse spaced-apart orientation, each nail gun also being mounted for selective vertical movement into and out of operative engagement with said boards;
means for flipping the first boards and stringers over after nailing;
means for feeding a plurality of second boards in predetermined transverse orientation onto the stringers on said feed path after flipping; and
means for fastening said second boards to said stringers, said second fastening means including a single vibratory nail bowl and a plurality of nail guns mounted in transverse spaced-apart orientation, each nail gun also being mounted for selective vertical movement into and out of operative engagement with said second boards to complete sequential manufacture of the pallets.

2. The apparatus of claim 1, wherein said means for feeding a plurality of stringers comprises:
a plurality of longitudinal hoppers disposed above said feed path.

3. The apparatus of claim 1, wherein said means for feeding a plurality of first boards comprises:
a transverse hopper disposed above said feed path.

4. The apparatus of claim 1, wherein said means for feeding a plurality of second boards comprises:
a transverse hopper disposed above said feed path.

5. The apparatus of claim 1, wherein said flipping means comprises:
a rotatable wheel defining a plurality of radially extending pockets for receiving the first boards and stringers after nailing.

6. The apparatus according to claim 5, wherein said rotatable wheel includes six radially extending pockets at equal circumferentially spaced intervals.

7. Apparatus for assembling pallets from stringers, boards and nails, comprising:
means defining a predetermined feed path having input and output ends;
a plurality of first hoppers disposed at the input end of the feed path for receiving a supply of said stringers;
means for simultaneously advancing a plurality of said stringers in predetermined, mutually spaced-apart longitudinal orientation along said feed path;
a second hopper disposed along said feed path for receiving a supply of first boards;
means for sequentially feeding the first boards in predetermined transverse orientation onto the stringers on said feed path;
first means for fastening the first boards to the stringers, said first fastening means including a single vibratory nail bowl and a plurality of associated first nail guns mounted for selective vertical movement into and out of operative engagement with the first boards to form semi-completed pallets;
means for disposed along said feed path for sequentially inverting the semi-completed pallets;
a third hopper disposed along said feed path for receiving a supply of second boards;
means for sequentially feeding the second boards in predetermined transverse orientation onto the stringers of the semi-complete pallets; and
second means for fastening said second boards to said stringers, said second fastening means including a single vibratory nail bowl and a plurality of second nail guns mounted for selective vertical movement into and out of operative engagement with said second boards to complete manufacture of the pallets at the output end of said feed path.

8. The apparatus of claim 7, wherein said first fastening means further includes means for adjustably supporting the first nail guns in selective, mutually spaced-apart positions above said feed path.

9. The apparatus according to claim 8, wherein said first fastening means further includes:
a mounting plate associated with each first nail gun;
each first nail gun including a cylinder with a movable drive pin and associated nail chuck;
a pair of mounting pads for supporting the cylinder of each first nail gun on said mounting plate, at least one of said mounting pads being engaged in a corresponding recess formed into said mounting plate; and
means for securing the cylinder and mounting pads to said mounting plate.

10. The apparatus of claim 7, wherein said second fastening means further includes means for adjustably supporting the second nail guns in selective, mutually spaced-apart positions above said feed path.

11. The apparatus according to claim 10, wherein said second fastening means further includes:
a mounting plate associated with each second nail gun;
each second nail gun including a cylinder with a movable drive pin and associated nail chuck;
a pair of mounting pads for supporting the cylinder of each second nail gun on said mounting plate, at least one of said mounting pads being engaged in a corresponding recess formed into said mounting plate; and
means for securing the cylinder and mounting pads to said mounting plate.

12. A fastening system for use in a pallet machine, which comprises:
a vibratory nail bowl for receiving a supply of loose nails, said nail bowl including an outlet;
a nail block adapted to individually receive nails from the outlet of said nail bowl and arrange said nails in a plurality of predetermined columns;
means for supporting said nail block for selective transverse positioning relative to the outlet of said nail bowl
a plurality of nail guns;
means for mounting said nail guns in mutually spaced apart orientation; and
means for simultaneously transferring individual nails from said nail block and feeding said nails to said nail guns.

13. The fastening system of claim 12, wherein the nails include shanks and heads, the shanks being relatively smaller than said heads, and wherein said nail block includes a plurality of transversely spaced-apart, generally vertical grooves adapted to receive the shanks of the nails.

14. The fastening system of claim 12, wherein said means for supporting said nail block includes linear shafts and linear bearings.

15. The fastening system of claim 12, wherein said means for supporting said nail block includes a linear actuator.

16. The fastening system of claim 12, wherein said nail gun mounting means is adjustable so that said nail guns can be positioned in selective, spaced-apart orientation.

17. The fastening system of claim 12, wherein said nail gun mounting means includes:
a mounting plate associated with each nail gun;
each nail gun including a cylinder with a movable drive pin and associated nail chuck;
a pair of mounting pads for supporting the cylinder of each nail gun on its associated mounting plate, at least one of said mounting pads being engaged in a corresponding recess formed into said mounting plate; and
means for securing the cylinder and mounting pads to said mounting plate.

18. The fastening system according to claim 17, further including:
a pair of generally horizontally extending, mutually spaced-apart linear shafts; and
a pair of linear bearings secured to each mounting plate, said linear bearing being supported on said linear shafts.

19. The fastening system of claim 12, wherein said nail transfer means includes:
a pick plate including predetermined openings therein;
means for supporting said pick plate for movement between blocking and feeding positions relative to said nail block; and
means for selectively actuating said plate

20. The fastening system according to claim 19, said means for supporting said pick plate includes a linear shaft and linear bearings.
